(19) United States
(12) Patent Application Publication
(10) Pub. No.: US 2022/0284529 A1
(43) Pub. Date: Sep. 8, 2022

(54) APPLICATION AND METHOD FOR BODYGUARD SERVICES

(71) Applicant: Ramesh Arumugam, Houston, TX (US)

(72) Inventor: Ramesh Arumugam, Houston, TX (US)

(21) Appl. No.: 17/192,082

(22) Filed: Mar. 4, 2021

(51) Int. Cl. G06Q 50/26; G06Q 20/38; G06Q 30/06; H04L 9/32

(52) U.S. Cl. CPC G06Q 50/265; G06Q 20/382; G06Q 30/0631; H04L 9/3247

(57) ABSTRACT

An application that allows users to register their bodyguard and protective services through the application, and through the same application, customers can hire, schedule, and pay for services

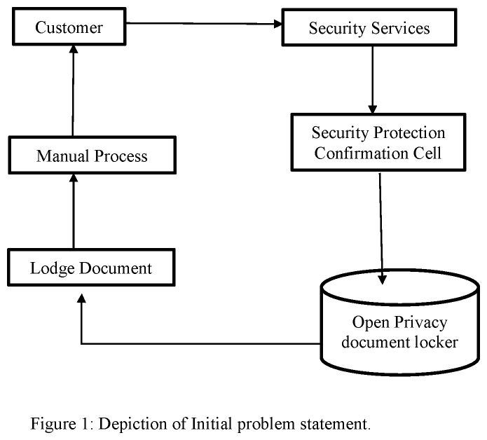

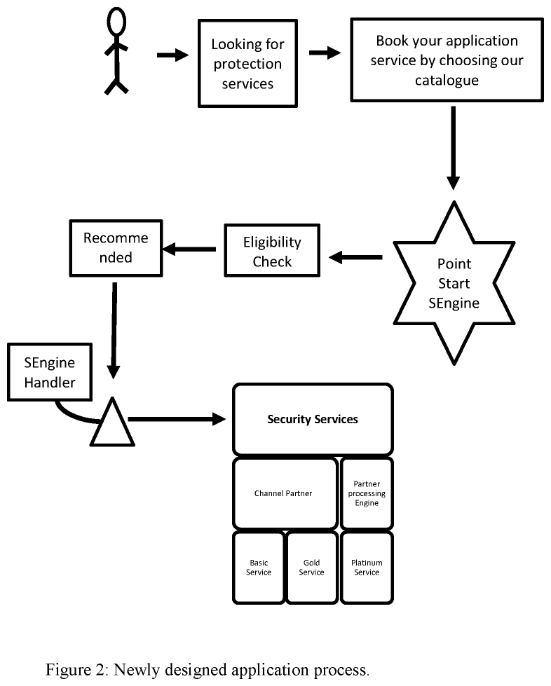

### CROSS REFERENCE OF RELATED APPLICATIONS

Not Available

### FIELD OF THE INVENTION

The present invention relates generally to the personal and commercial Bodyguard services, Bodyguard driver services and all other Bodyguard related security services application.

### BACKGROUND OF THE INVENTION

Personal bodyguard and Security services is still dream if you are not super rich and our goal is close this gap. Provide personal security and bodyguard to every consumer through a mobile application and website. COVID-19 has brought all the business to online processing, hiring various security services has been a challenge due to the stringent process. Hence we have come up with a unique process to diagnose the service needs and issue the customer with recommendations from protection cell and needing security service.

### SUMMARY

There is a need to procure bodyguard services. These services may include but are not limited to: armed protection, unarmed protection, vehicle escort, executive/VIP protective services, or any other services of a security/bodyguard nature.

The services can be procured in a manner that will facilitate the offer, procurement, purchase, and schedule of the service through the use of a mobile application. The application will work in the following steps

Law enforcement, military personnel, and other security experts will register their services on the application

Customers will use the application to procure bodyguard services, choosing specific services they need

Customers will schedule the services through the available scheduler in the application

Customers will pay for the service through the application's payment system

Vendor will collect a fee for the service

### DETAILED DESCRIPTION OF THE INVENTION

Existing system which shows transparent profile lodging and processing systems

Newly designed application process will have a separate digital security on every step of document processing and handling customer's sensitive data.

What is claimed is:

1. Unique point start process creation engine.

2. Validation with digitally signed documentation with privacy protection to avoid data leak.

3. Created Eligibility check to promote the new services and its traits.

4. Recommended services check for the customer to keep the customer satisfied and connected to our unique service application.

5. Connecting to various channel partners across other security services.

6. All payments and transactions to be processed through the application.
